(19) United States
(12) Patent Application Publication
(10) Pub. No.: US 2026/0200321 A1
(43) Pub. Date: Jul. 16, 2026

(54) DISPLAY CONTROL DEVICE, DISPLAY DEVICE, DISPLAY CONTROL METHOD, AND RECORDING MEDIUM

(71) Applicant: Panasonic Automotive Systems Co., Ltd., Kanagawa (JP)

(72) Inventors: Takami YAMAMOTO, Shiga (JP); Masahito OISHI, Kanagawa (JP); Daiki MATSUDA, Osaka (JP); Takeshi ITO, Kanagawa (JP)

(73) Assignee: Panasonic Automotive Systems Co., Ltd., Kanagawa (JP)

(21) Appl. No.: 19/429,882

(22) Filed: Dec. 22, 2025

(30) Foreign Application Priority Data
Jan. 14, 2025 (JP) 2025-004929

(51) Int. Cl. B60K 35/29; B60K 35/10

(52) U.S. Cl. CPC B60K 35/29; B60K 35/10; B60K 2360/175; B60K 2360/1868; B60K 2360/741

(57) ABSTRACT

A display control device includes: a determiner that determines the seating location of an occupant who has operated an operation unit configured to receive an operation for selecting image content to be displayed on at least one of display screens provided in a vehicle; an obtainer that obtains the autonomous driving level of the vehicle; and a display controller that causes the image content to be displayed on one or more display screens based on the operation received by the operation unit, the seating location, and the autonomous driving level. When an operation for displaying new image content is received by the operation unit while the image content is displayed on at least one of the display screens, the display controller changes the display mode of the image content that has already been displayed, to display the new image content based on the seating location and the autonomous driving level.

### CROSS REFERENCE TO RELATED APPLICATION

The present application is based on and claims priority of Japanese Patent Application No. 2025-004929 filed on January 14, 2025.

### FIELD

The present disclosure relates to a display control device, a display device, a display control method, and a recording medium.

### BACKGROUND

For example, Patent Literature (PTL) 1 discloses a vehicle display device. PTL 1 discloses that, in the vehicle display device, when an operation for displaying new content is received by an operation unit while content is displayed on one of a plurality of display units, a display controller changes a display mode of the content that has already been displayed based on a result of determination of a seating location by a determiner.

### CITATION LIST

### Patent Literature

PTL1: Japanese Unexamined Patent Application Publication No. 2019-182150

### SUMMARY

However, the vehicle display device according to the aforementioned PTL 1 can be improved upon.

In view of this, the present disclosure improves upon the above related art.

A display control device according to the present disclosure includes: a determiner that determines the seating location of an occupant who has operated an operation unit configured to receive an operation for selecting image content to be displayed on at least one of a plurality of display screens provided in a vehicle; an obtainer that obtains the autonomous driving level of the vehicle; and a display controller that causes the image content to be displayed on one or more of the plurality of display screens based on the operation received by the operation unit, the seating location, and the autonomous driving level. When an operation for displaying new image content is received by the operation unit while the image content is displayed on at least one of the plurality of display screens, the display controller changes the display mode of the image content that has already been displayed, to display the new image content based on the seating location and the autonomous driving level.

A display control device according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating the cabin of a vehicle in which a display system according to an embodiment is installed.

FIG. 2 is a block diagram illustrating the display system.

FIG. 3 is a flowchart illustrating an example operation of a display control device according to the embodiment.

FIG. 4A is a diagram illustrating how first image content that has already been displayed on a first display screen is changed to new image content and the first image content displayed on the first display screen is displayed on a second display screen.

FIG. 4B is a diagram illustrating how second image content that has already been displayed on the second display screen is changed to new image content.

FIG. 5 is a diagram illustrating how the first image content that has already been displayed on the first display screen is changed to new image content.

FIG. 6 is a flowchart illustrating an example operation of the display control device when priority is considered.

FIG. 7 is a diagram illustrating how the second image content that has already been displayed on the second display screen is changed to new image content and the second image content displayed on the second display screen is displayed on the first display screen.

FIG. 8 is a diagram illustrating how the first image content that has already been displayed on the first display screen is displayed across the first display screen and the second display screen.

FIG. 9A is a diagram illustrating how the first image content displayed on the first display screen is changed to emergency vehicle information and the first image content that has already been displayed on the first display screen is displayed in a reduced size.

FIG. 9B is a diagram illustrating how the first image content displayed on the first display screen is changed to manager notification information and the first image content that has already been displayed on the first display screen is displayed in a reduced size.

### DESCRIPTION OF EMBODIMENT

Hereinafter, an embodiment of the present disclosure will be described in detail with reference to the drawings. Each embodiment described below shows a specific example of the present disclosure. The numerical values, shapes, materials, elements, the arrangement and connection of the elements, steps, order the of steps, etc., shown in the following embodiments are mere examples and therefore do not limit the scope of the present disclosure. Among elements described in the following embodiments, those not described in any of the independent claims are described as optional elements.

Moreover, the figures are schematic illustrations and are not necessarily precise depictions. For example, the scales and other factors in the drawings do not necessarily match. In the figures, elements that are essentially the same share the same reference signs, and repeated description is omitted or simplified.

The following specifically describes an embodiment with reference to the drawings.

### EMBODIMENT

### Configuration and Functions

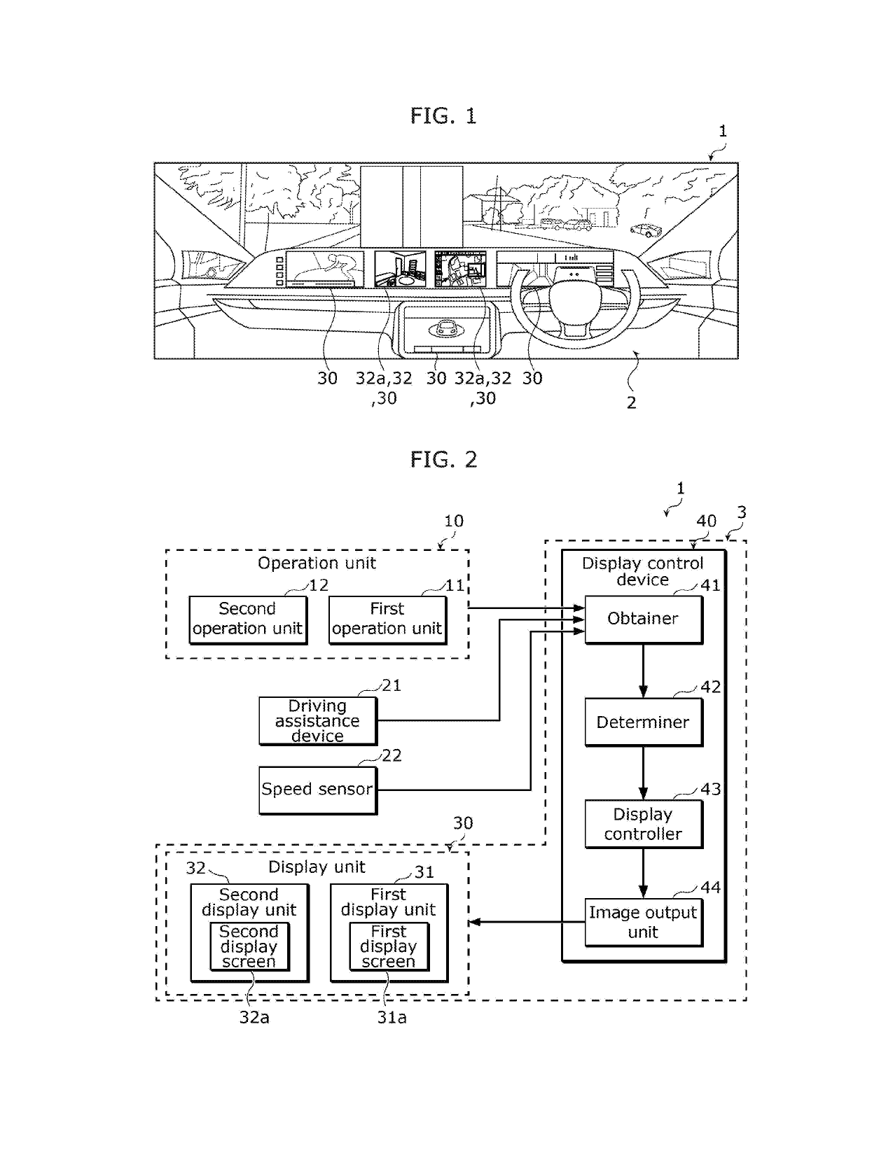

First, display system 1 using display control device 40, display device 3, a display control method, and a program in this embodiment will be described with reference to FIG. 1 and FIG. 2.

FIG. 1 is a diagram illustrating the cabin of vehicle 2 in which display system 1 according to the embodiment is installed. FIG. 2 is a block diagram illustrating display system 1.

As shown in FIG. 1, display system 1 is a system that can display a plurality of images on a plurality of respective display screens. In display system 1, a plurality of image contents can be displayed on at least one display screen of the plurality of display screens either automatically or manually by occupants. Further, display system 1 is used for, for example, vehicle 2 in which one or more display units 30 each having a display screen are placed. The area of the display screen of single display unit 30 may be divided into a plurality of display screens. In this case, display system 1 can display a plurality of images on the plurality of respective display screens resulting from dividing the area of single display unit 30. Further, when a plurality of display units 30 are provided in vehicle 2, display system 1 can display a plurality of images on the respective display screens of the plurality of display units 30.

Image content displayed on the plurality of display screens is image content based on applications, and includes information such as personal images, amusement images, navigation information, working conditions of vehicle instruments and in-vehicle equipment, and surrounding vehicle information. Personal images are, for example, images of the inside of an occupant's home, and images of messages of personal emails.

Amusement images are images providing music information, television viewing images, and the like. Navigation information is, for example, information for providing occupants with their current position and a route to the destination when vehicle 2 is traveling. Vehicle instruments are, for example, a speedometer, direction indicating lights, warning lights, an odometer, shift positions, a fuel gauge, and a water temperature gauge. Automotive equipment is, for example, an audio device, an in-vehicle lighting device, and seat devices. Surrounding vehicle information is, for example, information indicating whether there are other vehicles around vehicle 2, the number of them, their speeds, and the distances from vehicle 2 to the other vehicles.

Next, the configuration and functions of display system 1 will be described in more detail.

Display system 1 includes a plurality of operation units 10, driving assistance device 21, speed sensor 22, and display device 3.

Each of the plurality of operation units 10 is, for example, a slider bar and a switch, and is configured to receive an operation performed by an occupant of vehicle 2 and output an operation instruction according to the operation. For example, each of the plurality of operation units 10 can receive an operation instruction for an occupant to cause display unit 30 to display image content. The operation instruction includes the content of the instruction input by the occupant and the seat location linked to operation unit 10.

The plurality of operation units 10 include first operation unit 11 and second operation unit 12. First operation unit 11 is placed on the driver's side of vehicle 2 and corresponds to first display unit 31 described later. Further, second operation unit 12 is placed on the passenger side of vehicle 2 and corresponds to second display unit 32 described later. Note that this embodiment will be described using any one operation unit of the plurality of operation units 10 unless otherwise mentioned.

Each of the plurality of operation units 10 may be placed on the center console, the steering, the instrument panel, and the like of vehicle 2. Each operation unit 10 may be integrated with display unit 30. In this case, operation unit 10 is integrated with the display screen as a touch panel.

Driving assistance device 21 is a device for improving driving safety and driver comfort, and is configured to assist a driver who drives vehicle 2. Driving assistance device 21 has functions such as collision damage mitigation braking, lane keeping assist, and adaptive cruise control. Driving assistance device 21 can reduce accidents and driver fatigue by utilizing sensors, cameras, and the like.

Driving assistance device 21 can set an autonomous driving level, and can switch the autonomous driving level as appropriate. It is known that the autonomous driving levels are defined as six levels from 0 to 5. Driving assistance device 21 can output the current autonomous driving level to display control device 40.

Speed sensor 22 is provided in vehicle 2 and is configured to sense the traveling speed of vehicle 2. Note that speed sensor 22 may be a sensor that detects position information, such as a Global Positioning System (GPS) receiver, and the speed may be calculated from the change in the position information. Speed sensor 22 can output speed information indicating the traveling speed of vehicle 2 to display control device 40.

Display device 3 includes a plurality of display units 30 and display control device 40.

Each of the plurality of display units 30 is a Personal Computer (PC) provided with a liquid crystal display or the like, a mobile terminal, such as a smartphone, or an in-vehicle monitor, such as a car navigation system, an electronic mirror system, a multi-information display, or a head-up display.

The plurality of display units 30 are provided in vehicle 2. The plurality of display units 30 are arranged in a row in vehicle 2 so that occupants of vehicle 2 can see the plurality of display units 30 at once. This embodiment will be described mainly using first display unit 31 and second display unit 32 as examples of the plurality of display units 30.

First display unit 31 and second display unit 32 are configured to display image content by being controlled by display control device 40.

Each of the plurality of display units 30 has a display screen for displaying image content. First display unit 31 may have first display screen 31a. Further, second display unit 32 may have second display screen 32a. Note that first display screen 31a and second display screen 32a may be screens resulting from dividing the area of the display screen of single display unit 30. In this embodiment, first display screen 31a and second display screen 32a may be collectively referred to as a display screen.

In this embodiment, first display unit 31 and second display unit 32 are separate and independent, and are provided side by side in the left-right direction of vehicle 2. First display unit 31 is placed on the driver's side of vehicle 2. Further, second display unit 32 is placed on the passenger side of vehicle 2.

Display control device 40 is configured to control image content displayed on the plurality of display units 30. Display control device 40 can also display image content on at least one display unit 30 of the plurality of display units 30.

Display control device 40 includes obtainer 41, determiner 42, display controller 43, and image output unit 44.

Obtainer 41 is an input interface that can obtain various types of information. Obtainer 41 is configured to be able to obtain an operation instruction from each operation unit 10. Further, obtainer 41 is also configured to be able to obtain the autonomous driving level of vehicle 2 from driving assistance device 21. Furthermore, obtainer 41 is also configured to be able to obtain the speed information indicating the traveling speed of vehicle 2 from speed sensor 22. Note that although obtainer 41 obtains the operation instruction from operation unit 10, the autonomous driving level, and the speed information, a plurality of separate and independent obtainers 41 may be configured to obtain the operation instruction from operation unit 10, the autonomous driving level, and the speed information.

Obtainer 41 outputs the obtained operation instruction, autonomous driving level, and traveling speed to determiner 42.

Determiner 42 is configured to be able to determine a seating location of an occupant who has operated operation unit 10 that receives an operation for selecting image content to be displayed on at least one of a plurality of display screens provided in vehicle 2. Specifically, determiner 42 determines the seating location of the occupant who has operated operation unit 10 from the seat location linked to the operation instruction obtained from obtainer 41. Determiner 42 outputs the determination result to display controller 43.

Further, when the seating location of the occupant indicates the driver's seat, determiner 42 is also configured to be able to determine which one of the following ranges the autonomous driving level falls into: a first range; a second range in which the autonomous driving level is higher than the first range; and a third range in which the autonomous driving level is higher than the second range. For example, determiner 42 is configured to be able to determine whether the autonomous driving level falls into the third range or falls into either the first range or the second range by determining whether the autonomous driving level is greater than or equal to a predetermined value, and to be able to determine whether the autonomous driving level falls into the first range or the second range by determining whether the autonomous driving level is 0 or not. Determiner 42 outputs the range of the autonomous driving level, which is the result of the determination, to display controller 43.

Display controller 43 is configured to cause the image content to be displayed on one or more of the plurality of display screens based on the operation received by operation unit 10, the seating location, and the autonomous driving level. Specifically, in a state where the image content is displayed on at least one of the plurality of display screens, display controller 43 outputs an instruction to image output unit 44 to change the display mode of the image content that has already been displayed, to display the new image content based on the seating location and the autonomous driving level. Further, display controller 43 changes the display mode of the image content that has already been displayed so that the new image content is displayed in further consideration of the speed information.

Display controller 43 includes an Electronic Control Unit (ECU). The electronic control unit includes a computer system (e.g., System on a Chip (SoC)) including one or more processors and one or more memories, and an electronic circuit including transistors and the like. The processors include at least one of a Central Processing Unit (CPU), a Micro Processing Unit (MPU), a Graphics Processing Unit (GPU), and a Tensor Processing Unit (TPU). The memories include a Read Only Memory (ROM) and a Random Access Memory (RAM). The computer system may include an Application Specific Integrated Circuit (ASIC), a Field-Programmable Gate Array (FPGA), and the like.

Image output unit 44 causes target display unit 30 to display image content according to an instruction from display controller 43. This enables target display unit 30 to display the image content according to the instruction from display controller 43.

### Example Operation

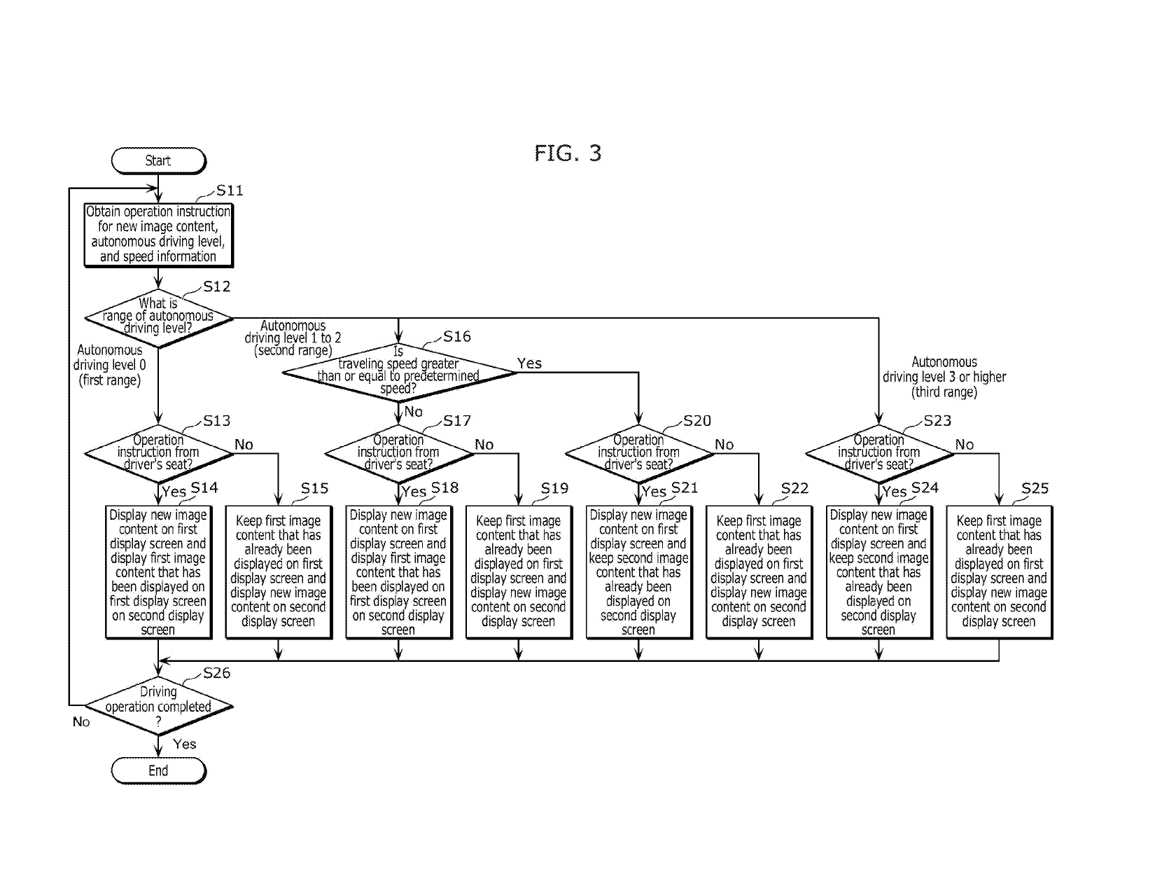

Next, an example operation of display system 1 using display control device 40, display device 3, the display control method, and the program in this embodiment will be described with reference to FIG. 3 to FIG. 5.

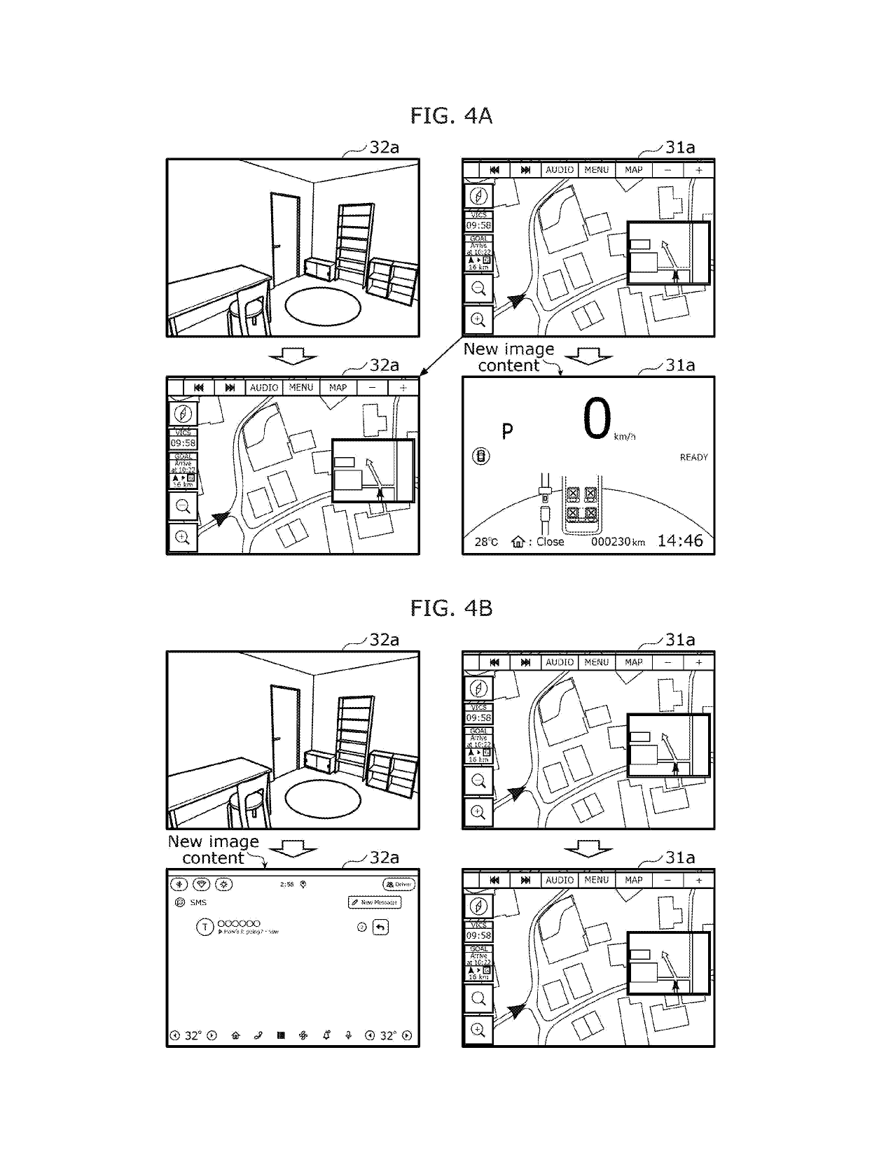

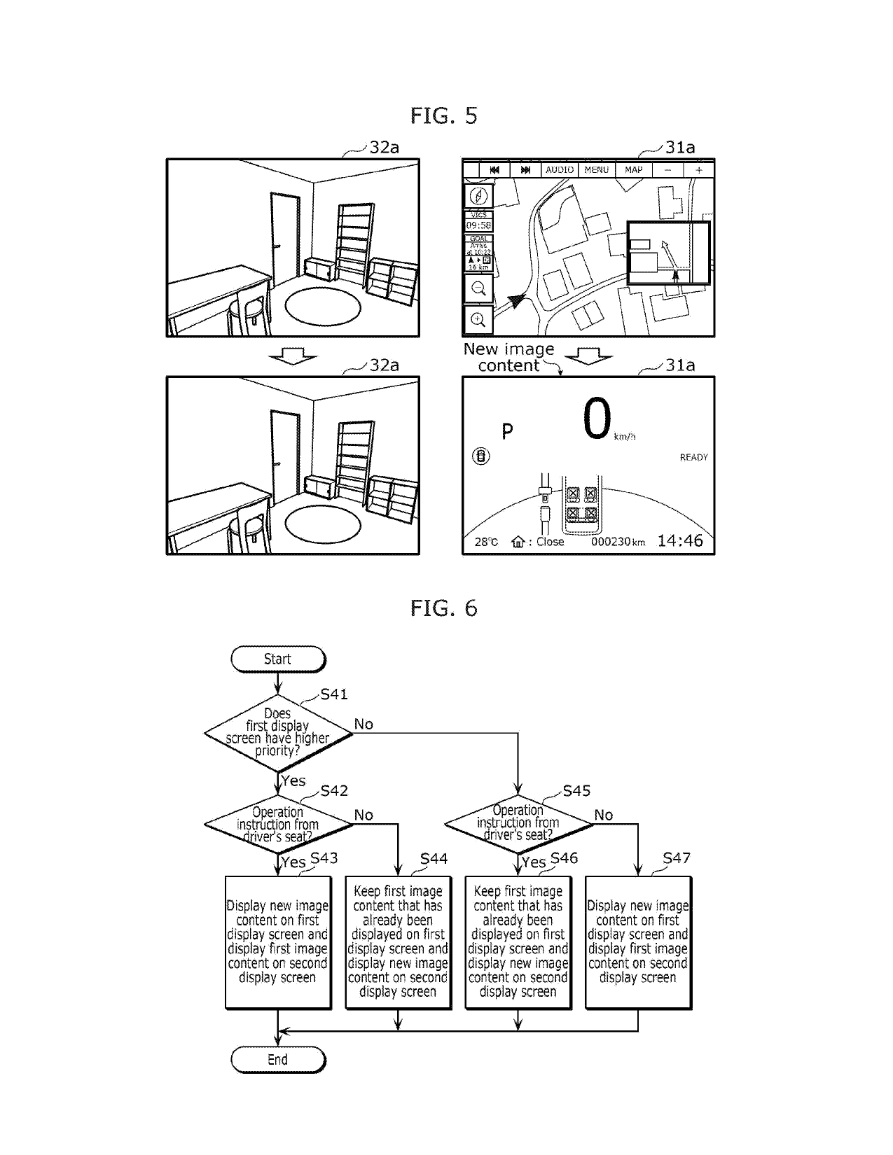

FIG. 3 is a flowchart illustrating an example operation of display control device 40 according to the embodiment. FIG. 4A is a diagram illustrating how first image content that has already been displayed on first display screen 31a is changed to new image content and the first image content displayed on first display screen 31a is displayed on second display screen 32a. FIG. 4B is a diagram illustrating how second image content that has already been displayed on second display screen 32a is changed to new image content. FIG. 5 is a diagram illustrating how the first image content that has already been displayed on first display screen 31a is changed to new image content. Note that the term "image content" is a general term for the first image content and the second image content.

Note that this example operation will be described using first display screen 31a of first display unit 31 and second display screen 32a of second display unit 32, and assumes a case where the first image content is displayed in advance on first display screen 31a and the second image content is displayed in advance on second display screen 32a.

First, an occupant inputs an operation instruction for displaying new image content to operation unit 10 provided in vehicle 2, thereby causing operation unit 10 to output an operation instruction for the new image content to display control device 40 of display device 3. Thus, obtainer 41 obtains the operation instruction for the new image content from operation unit 10, the autonomous driving level of vehicle 2 from driving assistance device 21, and the speed information indicating the traveling speed of vehicle 2 from speed sensor 22 (S11).

Next, determiner 42 determines which range the autonomous driving level falls into. In other words, determiner 42 determines which of the first range, the second range, and the third range the autonomous driving level falls into (S12). For example, the first range indicates when the autonomous driving level is 0, the second range indicates when the autonomous driving level is 1 or 2, and the third range indicates when the autonomous driving level is 3 or higher. In this case, determiner 42 may determine whether the autonomous driving level is greater than or equal to a predetermined value (e.g., the autonomous driving level is 3 or higher). When determining that the autonomous driving level is less than the predetermined value (e.g., the autonomous driving level is less than 3), determiner 42 may determine whether the autonomous driving level is 0 or not. This enables determiner 42 to determine which range it falls into.

Although this embodiment illustrates three ranges as an example, two ranges may be set, or four or more ranges may be set. Further, the autonomous driving levels in each range are not limited to those in this embodiment, but can be changed as appropriate. Further, the predetermined value is a preset threshold and can also be changed as appropriate.

Next, when determiner 42 determines that the autonomous driving level is 0, that is, falls into the first range (the first range in S12), determiner 42 determines whether the seat location indicated by the operation instruction corresponds to the driver's seat (S13).

As shown in FIG. 4A, when determiner 42 determines that the seat location indicated by the operation instruction corresponds to the driver's seat (Yes in S13), display controller 43 changes the display mode of first image content that has already been displayed on first display screen 31a to new image content, and changes second image content that has already been displayed on second display screen 32a to the first image content (S14).

On the other hand, as shown in FIG. 4B, when determiner 42 determines that the seat location indicated by the operation instruction does not correspond to the driver's seat (but to the passenger seat) (No in S13), display controller 43 keeps the display mode of the first image content that has already been displayed on first display screen 31a, and changes the display mode to change the second image content that has already been displayed on second display screen 32a to new image content (S15). At this time, display controller 43 does not display the second image content that has already been displayed on second display screen 32a.

Further, when determiner 42 determines that the autonomous driving level is 1 to 2, that is, falls into the second range (the second range in S12), determiner 42 determines whether the traveling speed indicated by the speed information is greater than or equal to a predetermined speed (S16).

When determiner 42 determines that the traveling speed is less than the predetermined speed (No in S16), determiner 42 determines whether the seat location indicated by the operation instruction corresponds to the driver's seat (S17).

As shown in FIG. 4A, when determiner 42 determines that the seat location indicated by the operation instruction corresponds to the driver's seat (Yes in S17), display controller 43 changes the first image content that has already been displayed on first display screen 31a to new image content, and changes the second image content that has already been displayed on second display screen 32a to the first image content (S18).

On the other hand, as shown in FIG. 4B, when determiner 42 determines that the seat location indicated by the operation instruction does not correspond to the driver's seat (but to the passenger seat) (No in S17), display controller 43 keeps the display mode of the first image content that has already been displayed on first display screen 31a, and changes the second image content that has already been displayed on second display screen 32a to new image content (S19).

Further, when determiner 42 determines that the traveling speed is greater than or equal to the predetermined speed (Yes in S16), determiner 42 determines whether the seat location indicated by the operation instruction corresponds to the driver's seat (S20).

As shown in FIG. 5, when determiner 42 determines that the seat location indicated by the operation instruction corresponds to the driver's seat (Yes in S20), display controller 43 changes the first image content that has already been displayed on first display screen 31a to new image content, and keeps the display mode of the second image content that has already been displayed on second display screen 32a (S21).

On the other hand, as shown in FIG. 4B, when determiner 42 determines that the seat location indicated by the operation instruction does not correspond to the driver's seat (but to the passenger seat) (No in S20), display controller 43 keeps the display mode of the first image content that has already been displayed on first display screen 31a, and changes the second image content that has already been displayed on second display screen 32a to new image content (S22).

Further, when determiner 42 determines that the autonomous driving level is 3 or higher, that is, falls into the third range (the third range in S12), determiner 42 determines whether the seat location indicated by the operation instruction corresponds to the driver's seat (S23).

As shown in FIG. 5, when determiner 42 determines that the seat location indicated by the operation instruction corresponds to the driver's seat (Yes in S23), display controller 43 changes the first image content that has already been displayed on first display screen 31a to new image content, and keeps the display mode of the second image content that has already been displayed on second display screen 32a (S24).

On the other hand, as shown in FIG. 4B, when determiner 42 determines that the seat location indicated by the operation instruction does not correspond to the driver's seat (but to the passenger seat) (No in S23), display controller 43 keeps the display mode of the first image content that has already been displayed on first display screen 31a, and changes the second image content that has already been displayed on second display screen 32a to new image content (S25).

Then, after passing through one of steps S14, S15, S18, S19, S21, S22, S24, and S25, determiner 42 determines whether the driving operation has been completed or not (S26). When determiner 42 determines that the driving operation has been completed, that is, the occupants have completed operation instructions to operation unit 10 (Yes in S26), determiner 42 ends the flowchart in FIG. 3. On the other hand, when determiner 42 determines that the driving operation has not been completed, that is, the occupants are continuing to give operation instructions to operation unit 10 (No in S26), determiner 42 returns to the process in step S11.

Further, in steps S15, S19, 22, and 25 above, when changing the second image content that has already been displayed on second display screen 32a to new image content, display controller 43 may reduce the size of the second image content that has already been displayed on second display screen 32a and superimpose it on a part of the new image content, or display the second image content that has already been displayed in a reduced size in an empty space in second display screen 32a left by displaying the changed new image content in a slightly reduced size.

Further, in steps S21 and S24 above, when changing the first image content that has already been displayed on first display screen 31a to new image content, display controller 43 may reduce the size of the first image content that has already been displayed on first display screen 31a and superimpose it on a part of the new image content, or display the first image content that has already been displayed in a reduced size in an empty space in first display screen 31a left by displaying the changed new image content in a slightly reduced size.

### Other Embodiments

The following content may also be included in this embodiment.

For example, a priority may be set for each of first display screen 31a and second display screen 32a in advance. At this time, when determiner 42 determines that the autonomous driving level is in the third range, or when determiner 42 determines that the autonomous driving level is in the second range and the traveling speed is greater than or equal to the predetermined speed, the image content that has already been displayed on a display screen with a higher priority may be changed to the new image content, and the image content that has already been displayed on a display screen with a lower priority may be changed to the image content that has already been displayed on the display screen with the higher priority.

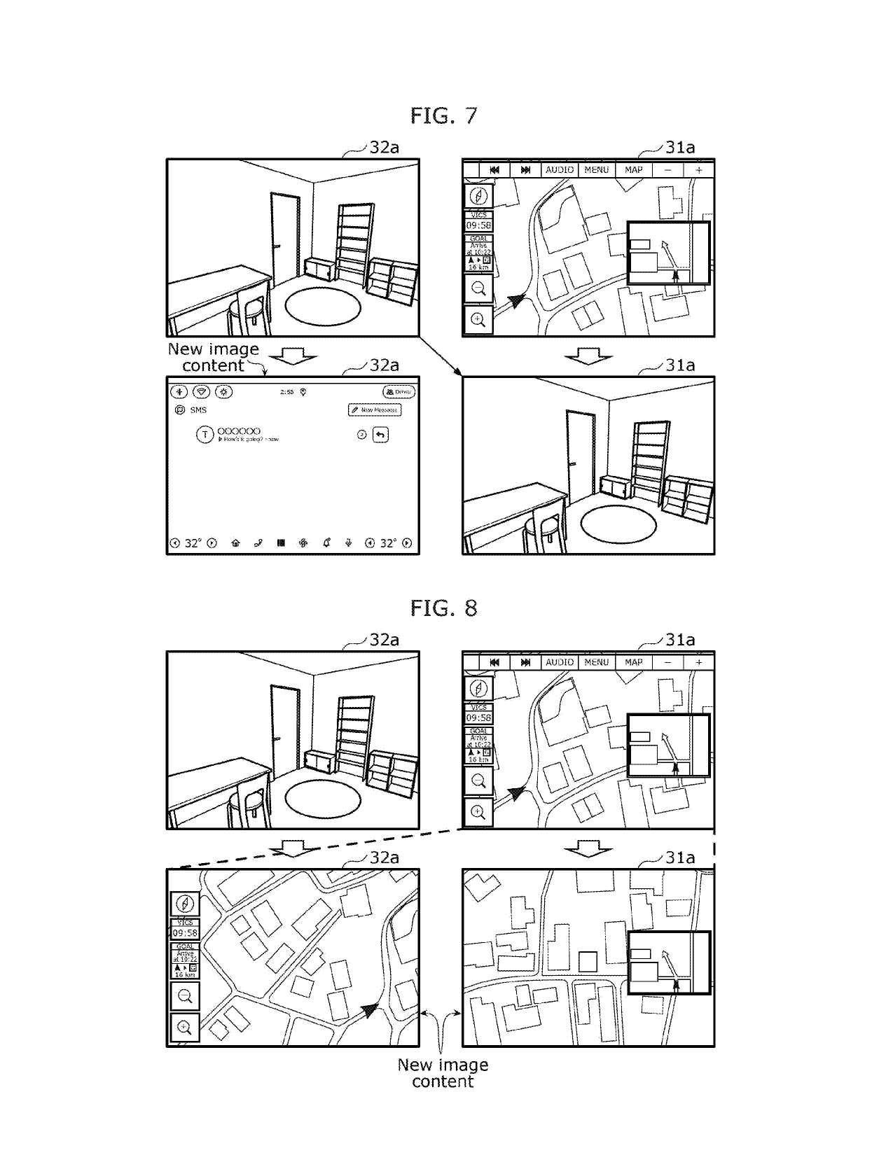

Here, another example operation of display system 1 using display control device 40, display device 3, the display control method, and the program in this embodiment will be described with reference to FIG. 6 to FIG. 7.

FIG. 6 is a flowchart illustrating an example operation of display control device 40 when priority is considered. FIG. 7 is a diagram illustrating how the second image content that has already been displayed on second display screen 32a is changed to new image content and the second image content displayed on second display screen 32a is displayed on first display screen 31a. Note that the following will be described using first display screen 31a of first display unit 31 and second display screen 32a of second display unit 32, and assumes that image content is displayed in advance on each of first display screen 31a and second display screen 32a.

First, determiner 42 determines whether first display screen 31a has a higher priority than second display screen 32a (S41).

When determiner 42 determines that first display screen 31a has a higher priority than second display screen 32a (Yes in S41), determiner 42 determines whether the seat location indicated by the operation instruction corresponds to the driver's seat (S42). Note that when the priority is the same, a configuration may be used such that either Yes or No is selected in S41.

As shown in FIG. 4A, when determiner 42 determines that the seat location indicated by the operation instruction corresponds to the driver's seat (Yes in S42), display controller 43 changes the first image content that has already been displayed on first display screen 31a to new image content, and changes the second image content that has already been displayed on second display screen 32a to the first image content (S43).

On the other hand, as shown in FIG. 4B, when determiner 42 determines that the seat location indicated by the operation instruction does not correspond to the driver's seat (but to the passenger seat) (No in S42), display controller 43 keeps the display mode of the first image content that has already been displayed on first display screen 31a, and changes the display mode to change the second image content that has already been displayed on second display screen 32a to new image content (S44).

When determiner 42 determines that first display screen 31a has a lower priority than second display screen 32a (No in S41), determiner 42 determines whether the seat location indicated by the operation instruction corresponds to the driver's seat (S45).

As shown in FIG. 5, when determiner 42 determines that the seat location indicated by the operation instruction corresponds to the driver's seat (Yes in S42), display controller 43 keeps the display mode of the second image content that has already been displayed on second display screen 32a, and changes the display mode to change the first image content that has already been displayed on first display screen 31a to new image content (S46).

On the other hand, as shown in FIG. 7, when determiner 42 determines that the seat location indicated by the operation instruction does not correspond to the driver's seat (but to the passenger seat) (No in S42), display controller 43 changes the second image content that has already been displayed on second display screen 32a to new image content, and changes the first image content that has already been displayed on first display screen 31a to the second image content (S47).

Then, determiner 42 ends the processing of the flowchart in FIG. 6.

As mentioned above, when determiner 42 determines that the autonomous driving level is in the third range, or when determiner 42 determines that the autonomous driving level is in the second range and the traveling speed is greater than or equal to the predetermined speed, the processing in FIG. 6 may be performed. In other words, the processing in FIG. 6 may be performed instead of steps S20, S21, and S22 in FIG. 3, or may be performed instead of steps S23, S24, and S25 in FIG. 3.

Note that the processing in FIG. 6 may be performed instead of steps S13, S14, and S15 in FIG. 3, or may be performed instead of steps S17, S18, and S19 in FIG. 3.

Further, in step S44 above, when changing the second image content that has already been displayed on second display screen 32a to new image content, display controller 43 may reduce the size of the second image content that has already been displayed on second display screen 32a and superimpose it on a part of the new image content, or display the second image content that has already been displayed in a reduced size in an empty space in second display screen 32a left by displaying the changed new image content in a slightly reduced size.

Further, in step S46 above, when changing the first image content that has already been displayed on first display screen 31a to new image content, display controller 43 may reduce the size of the first image content that has already been displayed on first display screen 31a and superimpose it on a part of the new image content, or display the first image content that has already been displayed in a reduced size in an empty space in first display screen 31a left by displaying the changed new image content in a slightly reduced size.

Furthermore, as shown in FIG. 8, the following content may also be included in this embodiment.

FIG. 8 is a diagram illustrating how the first image content that has already been displayed on first display screen 31a is displayed across first display screen 31a and second display screen 32a.

For example, as shown in FIG. 8, when Yes in step S42 above, display controller 43 may make a change to display the first image content that has already been displayed on first display screen 31a, which is the display screen with a higher priority, across first display screen 31a and second display screen 32a as new image content instead of the process in step S43.

For example, although not shown, when No in step S45 above, display controller 43 may make a change to display the second image content that has already been displayed on second display screen 32a, which is the display screen with a higher priority, across first display screen 31a and second display screen 32a as new image content instead of the process in step S47.

Further, when Yes in step S17 above, display controller 43 may make a change to display the first image content that has already been displayed on first display screen 31a across first display screen 31a and second display screen 32a as new image content instead of the process in step S18.

Further, when Yes in step S13 above, display controller 43 may make a change to display the first image content that has already been displayed on first display screen 31a across first display screen 31a and second display screen 32a as new image content instead of the process in step S14.

Note that in the above case, in response to an operation instruction for displaying new image content on the display screen with a higher priority, display controller 43 may make a change to display the new image content across first display screen 31a and second display screen 32a.

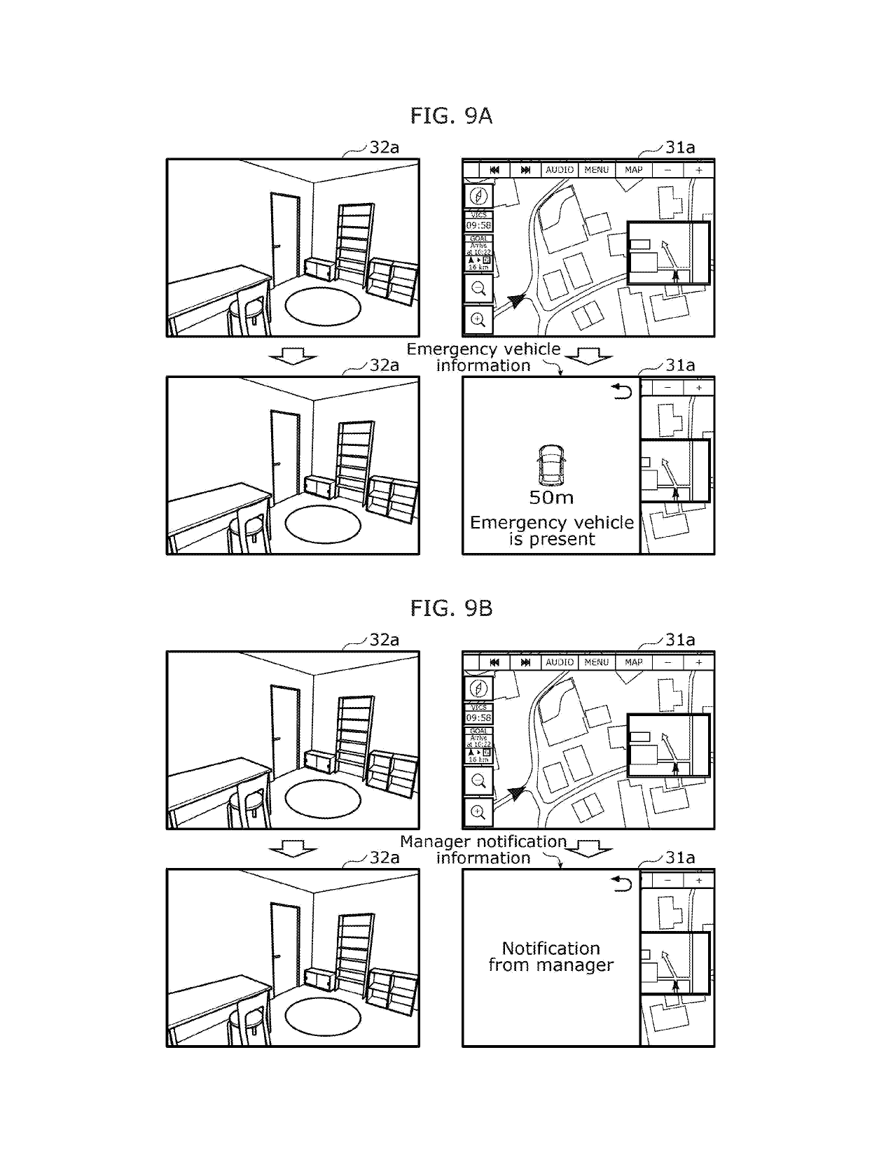

Furthermore, as shown in FIG. 9A, the following content may also be included in this embodiment.

FIG. 9A is a diagram illustrating how the first image content displayed on first display screen 31a is changed to emergency vehicle information and the first image content that has already been displayed on first display screen 31a is displayed in a reduced size. FIG. 9B is a diagram illustrating how the first image content displayed on first display screen 31a is changed to manager notification information and the first image content that has already been displayed on first display screen 31a is displayed in a reduced size.

For example, obtainer 41 can obtain emergency vehicle information. Although the emergency vehicle information is information indicating that an emergency vehicle approaching vehicle 2 is present, it may also contain emergent information, such as the presence of an accident site nearby.

In this case, as shown in FIG. 9A, display controller 43 changes image content that has already been displayed on at least one of the plurality of display screens to the emergency vehicle information. At this time, when changing the image content that has already been displayed on the display screen to the emergency vehicle information, display controller 43 may reduce the size of the image content that has already been displayed on the display screen, or may not display the image content. FIG. 9A illustrates a case in which display controller 43 displays the emergency vehicle information in a part of first display screen 31a, and displays the first image content that has already been displayed in the remaining part in a reduced size.

As shown in FIG. 9B, when obtainer 41 obtains manager notification information output from a manager in a case where determiner 42 determines that the autonomous driving level is in the third range, display controller 43 changes the image content that has already been displayed on at least one of the plurality of display screens to the manager notification information. Here, the manager can remotely give instructions or notifications to vehicle 2 when vehicle 2 is in danger or when vehicle 2 has a problem by monitoring the safe operation of vehicle 2 or monitoring the condition of vehicle 2.

At this time, when changing the image content that has already been displayed on the display screen to the manager notification information, display controller 43 may reduce the size of the image content that has already been displayed on the display screen, or may not display the image content. FIG. 9B illustrates a case in which display controller 43 displays the manager notification information in a part of first display screen 31a, and displays the first image content that has already been displayed in the remaining part in a reduced size.

Furthermore, the following content may also be included in this embodiment.

For example, operation unit 10 may also be able to receive a setting operation for preventing the image content to be displayed on at least one of the plurality of display screens from being changed to different image content. In this case, even when operation unit 10 receives an operation instruction for changing the image content to different image content, display controller 43 does not change the image content to be displayed on the at least one of the plurality of display screens for which the setting operation is received. In other words, display control device 40 of this embodiment may have an image lock function that can prevent image content displayed on a display screen of display unit 30 from being interrupted by an operation instruction from an occupant.

### Operations and Effects

Next, the operations and effects of display control device 40, display device 3, the display control method, and the program of this embodiment will be described.

However, it is expected that further development of autonomous driving technology in the future will eliminate the need for the driver to operate the vehicle, and thus, in the information presentation device in the aforementioned PTL 1, there may be cases where information necessary for the driver does not need to be displayed. In this case, there is a problem that simply changing the display mode of image content based only on the result of determination of the seating location as in the aforementioned PTL 1 will reduce convenience for occupants.

Therefore, display control device 40 of technique 1 according to this embodiment includes: determiner 42 that determines the seating location of an occupant who has operated operation unit 10 configured to receive an operation for selecting image content to be displayed on at least one of a plurality of display screens provided in vehicle 2; obtainer 41 that obtains an autonomous driving level of vehicle 2; and display controller 43 that causes the image content to be displayed on one or more of the plurality of display screens based on the operation received by operation unit 10, the seating location, and the autonomous driving level. When an operation for displaying new image content is received by operation unit 10 while the image content is displayed on at least one of the plurality of display screens, display controller 43 changes the display mode of the image content that has already been displayed, to display the new image content based on the seating location and the autonomous driving level.

According to this, for example, when the seating location indicates the driver's seat, the image content desired by the driver can be displayed on the display screen on the passenger side when the autonomous driving level is low, and the image content desired by the driver can be displayed on the display screen on the driver's side when the autonomous driving level is high.

Therefore, when the autonomous driving level is high and the driver does not require much operation of vehicle 2, the image content that has already been displayed on the display screen on the passenger side can be prevented from being overwritten with different image content due to the driver's operation. On the other hand, when the autonomous driving level is low and the driver has to pay attention to the operation of vehicle 2, the image content that has already been displayed on the display screen on the passenger side can be overwritten with different image content through the driver's operation.

Thus, according to this display control device 40, it is possible to improve the convenience for occupants.

In particular, when the autonomous driving level is low, the image content that has already been displayed on the display screen on the passenger side can be overwritten with different image content through the driver's operation, which makes it easier for the driver to recognize information about vehicle 2, and thus can suppress the reduction in the safety of vehicle 2.

Display control device 40 of technique 2 according to this embodiment is display control device 40 described in technique 1. In this case, the plurality of display screens include first display screen 31a and second display screen 32a, first display screen 31a is placed on the driver's side of vehicle 2, and second display screen 32a is placed on the passenger side of vehicle 2.

According to this, it is possible to assign first display screen 31a to the driver and second display screen 32a to the occupant of the passenger seat. This can improve the convenience for the driver and the occupant of the passenger seat.

Display control device 40 of technique 3 according to this embodiment is display control device 40 described in technique 2. In this case, determiner 42 determines which one of the following ranges the autonomous driving level falls into: a first range; a second range in which the autonomous driving level is higher than the first range; and a third range in which the autonomous driving level is higher than the second range, and display controller 43 changes a display mode of at least one of first image content that has already been displayed on first display screen 31a or second image content that has already been displayed on second display screen 32a, to display the new image content based on the seating location and a range that the autonomous driving level determined by determiner 42 falls into.

According to this, the new image content can be displayed on first display screen 31a and/or second display screen 32a depending on the seating location and the range determined by determiner 42.

Display control device 40 of technique 4 according to this embodiment is display control device 40 described in technique 3. In this case, in a case where determiner 42 determines that the autonomous driving level is in the third range: when the seating location of the occupant indicates a driver's seat, display controller 43 changes the first image content that has already been displayed on first display screen 31a to the new image content, and keeps the display mode of the second image content that has already been displayed on second display screen 32a; and when the seating location of the occupant indicates a passenger seat, display controller 43 keeps the display mode of the first image content that has already been displayed on first display screen 31a, and changes the second image content that has already been displayed on second display screen 32a to the new image content.

According to this, in the third range, in which the autonomous driving level is high, the driver is considered not to require as much operation of vehicle 2 as in the first range and the second range. Therefore, when the seating location indicates the driver's seat, it is possible to display the new image content desired by the driver on first display screen 31a and keep the second image content on second display screen 32a. This allows the occupant of the passenger seat to continue watching the second image content that has already been displayed on second display screen 32a.

Further, when the seating location indicates the passenger seat, it is possible to display the new image content desired by the occupant of the passenger seat on second display screen 32a and keep the first image content on first display screen 31a. This allows keeping the first image content on first display screen 31a seen by the driver, and allows the occupant of the passenger seat to watch the new image content on second display screen 32a. This can improve the convenience for the driver and the occupant of the passenger seat, and can also suppress the reduction in the safety of vehicle 2.

Display control device 40 of technique 5 according to this embodiment is display control device 40 described in technique 3. In this case, obtainer 41 obtains speed information indicating the traveling speed of vehicle 2, determiner 42 determines whether the traveling speed indicated by the speed information is greater than or equal to a predetermined speed, and when determiner 42 determines that the autonomous driving level is in the second range, display controller 43 further changes the display mode of at least one of the first image content that has already been displayed or the second image content that has already been displayed, to display the new image content in consideration of a result of the determination on the traveling speed by determiner 42.

According to this, even when the autonomous driving level is in the second range, vehicle 2 is considered to be traveling on a highway or the like when the traveling speed is high, and the driver is considered not to require as much operation of vehicle 2 as when driving on a general road or the like. In this case, for example, the second image content that has already been displayed on the display screen on the passenger side can be prevented from being overwritten with different image content due to the driver's operation.

On the other hand, when the traveling speed is low, vehicle 2 is considered to be traveling on a general road, and the driver is considered to need to be careful about the operation of vehicle 2. In this case, for example, the second image content that has already been displayed on the display screen on the passenger side can be overwritten with different image content through the driver's operation.

This can improve the convenience for the driver and the occupant of the passenger seat, and can also suppress the reduction in the safety of vehicle 2.

Display control device 40 of technique 6 according to this embodiment is display control device 40 described in technique 3. In this case, in a case where determiner 42 determines that the autonomous driving level is in the second range and the traveling speed is greater than or equal to the predetermined speed: when the seating location of the occupant indicates a driver's seat, display controller 43 changes the first image content that has already been displayed on first display screen 31a to the new image content, and keeps the display mode of the second image content that has already been displayed on second display screen 32a; and when the seating location of the occupant indicates a passenger seat, display controller 43 keeps the display mode of the first image content that has already been displayed on first display screen 31a, and changes the second image content that has already been displayed on second display screen 32a to the new image content.

According to this, even when the autonomous driving level is in the second range, vehicle 2 is considered to be traveling on a highway or the like when the traveling speed is high, and the driver is considered not to require as much operation of vehicle 2 as when driving on a general road or the like. In this case, for example, the second image content that has already been displayed on the display screen on the passenger side can be prevented from being overwritten with different image content due to the driver's operation.

On the other hand, it is possible to display the new image content on second display screen 32a though an operation performed by the occupant of the passenger seat while keeping displaying the first image content for the driver displayed on first display screen 31a.

This can improve the convenience for the driver and the occupant of the passenger seat, and can also suppress the reduction in the safety of vehicle 2.

Display control device 40 of technique 7 according to this embodiment is display control device 40 described in technique 3. In this case, in a case where determiner 42 determines that the autonomous driving level is in the second range and the traveling speed is less than the predetermined speed: when the seating location of the occupant indicates a driver's seat, display controller 43 changes the first image content that has already been displayed on the first display screen 31a to new image content, and changes the second image content that has already been displayed on second display screen 32a to the first image content; and when the seating location of the occupant indicates a passenger seat, display controller 43 keeps the display mode of the first image content that has already been displayed on first display screen 31a, and changes the second image content that has already been displayed on second display screen 32a to the new image content.

According to this, even when the autonomous driving level is in the second range, vehicle 2 is considered to be traveling on a general road or the like when the traveling speed is low, and the driver is considered to need to be careful about the operation of vehicle 2. In this case, for example, the second image content that has already been displayed on the display screen on the passenger side can be overwritten with different image content through the driver's operation.

On the other hand, it is possible to display the new image content on second display screen 32a though an operation performed by the occupant of the passenger seat while keeping displaying the first image content for the driver displayed on first display screen 31a.

This can improve the convenience for the driver and the occupant of the passenger seat, and can also suppress the reduction in the safety of vehicle 2.

Display control device 40 of technique 8 according to this embodiment is display control device 40 described in technique 3. In this case, a priority is set for each of first display screen 31a and second display screen 32a in advance, and when determiner 42 determines that the autonomous driving level is in the third range, display controller 43: changes the image content that has already been displayed on a display screen with a higher priority to the new image content; and changes the image content that has already been displayed on a display screen with a lower priority to the image content that has already been displayed on the display screen with the higher priority.

According to this, when the autonomous driving level is in the third range, the driver is considered not to require as much operation of vehicle 2 as in the first range and the second range. In this case, since the image content displayed on the display screen with a lower priority can be changed to the image content displayed on the display screen with a higher priority, it is possible to increase the priority of first display screen 31a on the driver's side, or increase the priority of second display screen 32a on the passenger side, as appropriate.

Display control device 40 of technique 9 according to this embodiment is display control device 40 described in technique 5. In this case, a priority is set for each of first display screen 31a and second display screen 32a in advance, and when determiner 42 determines that the autonomous driving level is in the second range and the traveling speed is greater than or equal to the predetermined speed, display controller 43: changes the image content that has already been displayed on a display screen with a higher priority to the new image content; and changes the image content that has already been displayed on a display screen with a lower priority to the image content that has already been displayed on the display screen with the higher priority.

According to this, even when the autonomous driving level is in the second range, vehicle 2 is considered to be traveling on a highway or the like when the traveling speed is high, and the driver is considered not to require as much operation of vehicle 2 as when driving on a general road or the like. In this case, since the image content displayed on the display screen with a lower priority can be changed to the image content displayed on the display screen with a higher priority, it is possible to increase the priority of first display screen 31a on the driver's side, or increase the priority of second display screen 32a on the passenger side, as appropriate.

Display control device 40 of technique 10 according to this embodiment is display control device 40 described in technique 1. In this case, when obtainer 41 obtains emergency vehicle information indicating that an emergency vehicle approaching vehicle 2 is present, display controller 43 changes the image content that has already been displayed on at least one of the plurality of display screens to the emergency vehicle information.

According to this, the driver can recognize the approach of an emergency vehicle, and thus can take some action against the approaching emergency vehicle.

Display control device 40 of technique 11 according to this embodiment is display control device 40 described in technique 3. In this case, when obtainer 41 obtains manager notification information output from a manager who manages autonomous driving of vehicle 2 in a case where determiner 42 determines that the autonomous driving level is in the third range, display controller 43 changes the image content that has already been displayed on at least one of the plurality of display screens to the manager notification information.

According to this, the driver can recognize the manager notification information, and thus can take some action against the manager notification information.

Display control device 40 of technique 12 according to this embodiment is display control device 40 described in technique 3. In this case, in a case where determiner 42 determines that the autonomous driving level is in the first range: when the seating location of the occupant indicates a driver's seat, display controller 43 changes the first image content that has already been displayed on first display screen 31a to the new image content, and changes the second image content that has already been displayed on second display screen 32a to the first image content; and when the seating location of the occupant indicates a passenger seat, display controller 43 keeps the display mode of the first image content that has already been displayed on first display screen 31a, and changes the second image content that has already been displayed on second display screen 32a to the new image content.

According to this, when the autonomous driving level is in the first range, the driver is considered to need to be careful about the operation of vehicle 2. In this case, for example, the second image content that has already been displayed on the display screen on the passenger side can be overwritten with different image content through the driver's operation.

On the other hand, it is possible to display the new image content on second display screen 32a though an operation performed by the occupant of the passenger seat while keeping displaying the first image content for the driver displayed on first display screen 31a.

This can improve the convenience for the driver and the occupant of the passenger seat, and can also suppress the reduction in the safety of vehicle 2.

Display control device 40 of technique 13 according to this embodiment is display control device 40 described in technique 3 or 5. In this case, a priority is set for each of first display screen 31a and second display screen 32a in advance, and display controller 43 makes a change to display, as the new image content, the image content that has already been displayed on a display screen with a higher priority, across first display screen 31a and second display screen 32a.

According to this, the image content that has already been displayed on the display screen with a higher priority can be displayed in an enlarged size.

Display control device 40 of technique 14 according to this embodiment is display control device 40 described in technique 5. In this case, when the seating location of the occupant indicates a driver's seat in a case where determiner 42 determines that the autonomous driving level is in the second range and the traveling speed is less than the predetermined speed, display controller 43 makes a change to display, as the new image content, the first image content that has already been displayed on first display screen 31a, across first display screen 31a and second display screen 32a.

According to this, the image content that has already been displayed on the display screen with a higher priority can be displayed in an enlarged size.

Display control device 40 of technique 15 according to this embodiment is display control device 40 described in technique 3. In this case, when the seating location of the occupant indicates a driver's seat in a case where determiner 42 determines that the autonomous driving level is in the first range, display controller 43 makes a change to display, as the new image content, the first image content that has already been displayed on first display screen 31a, across first display screen 31a and second display screen 32a.

According to this, the image content that has already been displayed on the display screen with a higher priority can be displayed in an enlarged size.

Display control device 40 of technique 16 according to this embodiment is display control device 40 described in any one of techniques 1 to 15. In this case, when displaying the new image content, display controller 43 reduces a size of the image content that has already been displayed or does not display the image content.

According to this, it is possible to display only new image content, or to display both the new image content and image content that has already been displayed. This can improve the convenience for the driver and the occupant of the passenger seat.

Display control device 40 of technique 17 according to this embodiment is display control device 40 described in any one of techniques 1 to 16. In this case, operation unit 10 is configured to receive a setting operation for preventing the image content to be displayed on at least one of the plurality of display screens from being changed to different image content, and display controller 43 does not change the image content to be displayed on the at least one of the plurality of display screens for which the setting operation is received.

According to this, making a setting in advance allows preventing the image content on the display screen from being changed to different image content. This can improve the convenience for the driver and the occupant of the passenger seat.

Display control device 40 of technique 18 according to this embodiment is display control device 40 described in any one of techniques 2 to 9, 11, 12, 14, and 15. In this case, first display screen 31a and second display screen 32a are screens resulting from dividing an area of the display screen of single display unit 30.

According to this, display control device 40 of this embodiment can also be applied to vehicle 2 provided with only the display screen of a single display unit 30.

Display control device 40 of technique 19 according to this embodiment is display control device 40 described in any one of techniques 2 to 9, 11, 12, 14, and 15. In this case, first display unit 31 provided in vehicle 2 includes first display screen 31a, second display unit 32 provided in vehicle 2 includes second display screen 32a, and first display unit 31 and second display unit 32 are separately and independently provided in vehicle 2.

According to this, display control device 40 of this embodiment can be applied to vehicle 2 provided with two or more display units 30.

Display device 3 of technique 20 according to this embodiment includes: display control device 40 described in any one of techniques 1 to 19; and the plurality of display screens.

This display device 3 also has the same operations and effects as above.

A display control method of technique 21 according to this embodiment includes: determining, by determiner 42, a seating location of an occupant who has operated operation unit 10 configured to receive an operation for selecting image content to be displayed on at least one of a plurality of display screens provided in vehicle 2; obtaining, by obtainer 41, an autonomous driving level of vehicle 2; causing, by display controller 43, the image content to be displayed on at least one of the plurality of display screens based on the operation received by operation unit 10, the seating location, and the autonomous driving level; and when an operation for displaying new image content is received by operation unit 10 while the image content is displayed on at least one of the plurality of display screens, changing, by display controller 43, a display mode of the image content that has already been displayed, to display the new image content based on the seating location and the autonomous driving level.

This display control method also has the same operations and effects as above.

A program of technique 22 according to this embodiment is a program executable by a computer to execute the display control method of technique 21.

This program also has the same operations and effects as above.

### Other Variations

Although the display control device according to the present disclosure has been described based on the aforementioned embodiments, the present disclosure is not limited to these embodiments. Forms obtained by various modifications to any of the embodiments which may be conceived by those skilled in the art may be also included in the range of the present disclosure so long as they do not depart from the essence of the present disclosure.

For example, the determiner, the display controller, and the image output unit included in the aforementioned display control device or the display device are implemented as a large scale integration (LSI) circuit that is typically an integrated circuit. These functions may be separately implemented as a single chip or some or all of the functions may be integrated into a single ship.

These functions need not be implemented as LSIs but may be implemented as dedicated circuits or genera-purpose processors. A field programmable gate array (FPGA) that can be programmed or a reconfigurable processor that can reconfigure the connection or configuration of circuit cells in the LSI may be used.

It should be noted that in the foregoing embodiment, each element may be configured by dedicated hardware or may be implemented by executing a software program suitable for the element. Each element may be implemented by a program executor such as a CPU or a processor reading out and executing a software program recorded onto a recording medium such as a hard disk or semiconductor memory.

All of the numbers used above are to illustrate examples for specifically explaining the present disclosure, and therefore, the embodiment of the present disclosure is not limited to the numbers.

Moreover, division of functional blocks in a block diagram is one example and a plurality of functional blocks may be implemented as a single function or a single functional block may be divided into a plurality of functional blocks or some of the functions may be displaced to another function block. A single hardware or software may process functions of multiple functional blocks with similar functions in parallel or time division.

An order of steps executed in a flowchart is to illustrate an example for specifically explaining the present disclosure, and an order other than that order may be used. Some of the steps may be executed at the same time (in parallel) with other steps.

Embodiments obtained by modifications that may be conceived by those skilled in the art and other embodiments to the above embodiments, as well as embodiments realized by combining arbitrary elements and functions in the embodiments without departing from the spirit of the present disclosure, are also included in the present disclosure.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2025-004929 filed on January 14, 2025.

### Industrial Applicability

The present disclosure is useful in a moving body such as a vehicle in which a display control device or a display device is installed.

1. A display control device comprising:
a determiner that determines a seating location of an occupant who has operated an operation unit configured to receive an operation for selecting image content to be displayed on at least one of a plurality of display screens provided in a vehicle;
an obtainer that obtains an autonomous driving level of the vehicle; and
a display controller that causes the image content to be displayed on one or more of the plurality of display screens based on the operation received by the operation unit, the seating location, and the autonomous driving level, wherein
when an operation for displaying new image content is received by the operation unit while the image content is displayed on at least one of the plurality of display screens, the display controller changes a display mode of the image content that has already been displayed, to display the new image content based on the seating location and the autonomous driving level.

2. The display control device according to claim 1, wherein
the plurality of display screens include a first display screen and a second display screen,
the first display screen is placed on a driver’s side of the vehicle, and
the second display screen is placed on a passenger side of the vehicle.

3. The display control device according to claim 2, wherein
the determiner determines which one of the following ranges the autonomous driving level falls into: a first range; a second range in which the autonomous driving level is higher than the first range; and a third range in which the autonomous driving level is higher than the second range, and
the display controller changes a display mode of at least one of first image content that has already been displayed on the first display screen or second image content that has already been displayed on the second display screen, to display the new image content based on the seating location and a range that the autonomous driving level determined by the determiner falls into.

4. The display control device according to claim 3, wherein
in a case where the determiner determines that the autonomous driving level is in the third range:
when the seating location of the occupant indicates a driver’s seat, the display controller changes the first image content that has already been displayed on the first display screen to the new image content, and keeps the display mode of the second image content that has already been displayed on the second display screen; and
when the seating location of the occupant indicates a passenger seat, the display controller keeps the display mode of the first image content that has already been displayed on the first display screen, and changes the second image content that has already been displayed on the second display screen to the new image content.

5. The display control device according to claim 3, wherein
the obtainer obtains speed information indicating a traveling speed of the vehicle,
the determiner determines whether the traveling speed indicated by the speed information is greater than or equal to a predetermined speed, and
when the determiner determines that the autonomous driving level is in the second range, the display controller further changes the display mode of at least one of the first image content that has already been displayed or the second image content that has already been displayed, to display the new image content in consideration of a result of the determination on the traveling speed by the determiner.

6. The display control device according to claim 5, wherein
in a case where the determiner determines that the autonomous driving level is in the second range and the traveling speed is greater than or equal to the predetermined speed:
when the seating location of the occupant indicates a driver’s seat, the display controller changes the first image content that has already been displayed on the first display screen to the new image content, and keeps the display mode of the second image content that has already been displayed on the second display screen; and
when the seating location of the occupant indicates a passenger seat, the display controller keeps the display mode of the first image content that has already been displayed on the first display screen, and changes the second image content that has already been displayed on the second display screen to the new image content.

7. The display control device according to claim 5, wherein
in a case where the determiner determines that the autonomous driving level is in the second range and the traveling speed is less than the predetermined speed:
when the seating location of the occupant indicates a driver’s seat, the display controller changes the first image content that has already been displayed on the first display screen to the new image content, and changes the second image content that has already been displayed on the second display screen to the first image content; and
when the seating location of the occupant indicates a passenger seat, the display controller keeps the display mode of the first image content that has already been displayed on the first display screen, and changes the second image content that has already been displayed on the second display screen to the new image content.

8. The display control device according to claim 3, wherein
a priority is set for each of the first display screen and the second display screen in advance, and
when the determiner determines that the autonomous driving level is in the third range, the display controller:
changes the image content that has already been displayed on a display screen with a higher priority to the new image content; and
changes the image content that has already been displayed on a display screen with a lower priority to the image content that has already been displayed on the display screen with the higher priority.

9. The display control device according to claim 5, wherein
a priority is set for each of the first display screen and the second display screen in advance, and
when the determiner determines that the autonomous driving level is in the second range and the traveling speed is greater than or equal to the predetermined speed, the display controller:
changes the image content that has already been displayed on a display screen with a higher priority to the new image content; and
changes the image content that has already been displayed on a display screen with a lower priority to the image content that has already been displayed on the display screen with the higher priority.

10. The display control device according to claim 1, wherein
when the obtainer obtains emergency vehicle information indicating that an emergency vehicle approaching the vehicle is present, the display controller changes the image content that has already been displayed on at least one of the plurality of display screens to the emergency vehicle information.

11. The display control device according to claim 3, wherein
when the obtainer obtains manager notification information output from a manager who manages autonomous driving of the vehicle in a case where the determiner determines that the autonomous driving level is in the third range, the display controller changes the image content that has already been displayed on at least one of the plurality of display screens to the manager notification information.

12. The display control device according to claim 3, wherein
in a case where the determiner determines that the autonomous driving level is in the first range:
when the seating location of the occupant indicates a driver’s seat, the display controller changes the first image content that has already been displayed on the first display screen to the new image content, and changes the second image content that has already been displayed on the second display screen to the first image content; and
when the seating location of the occupant indicates a passenger seat, the display controller keeps the display mode of the first image content that has already been displayed on the first display screen, and changes the second image content that has already been displayed on the second display screen to the new image content.

13. The display control device according to claim 3, wherein
a priority is set for each of the first display screen and the second display screen in advance, and
the display controller makes a change to display, as the new image content, the image content that has already been displayed on a display screen with a higher priority, across the first display screen and the second display screen.

14. The display control device according to claim 5, wherein
when the seating location of the occupant indicates a driver’s seat in a case where the determiner determines that the autonomous driving level is in the second range and the traveling speed is less than the predetermined speed, the display controller makes a change to display, as the new image content, the first image content that has already been displayed on the first display screen, across the first display screen and the second display screen.

15. The display control device according to claim 3, wherein
when the seating location of the occupant indicates a driver’s seat in a case where the determiner determines that the autonomous driving level is in the first range, the display controller makes a change to display, as the new image content, the first image content that has already been displayed on the first display screen, across the first display screen and the second display screen.

16. The display control device according to claim 1, wherein
when displaying the new image content, the display controller reduces a size of the image content that has already been displayed or does not display the image content.

17. The display control device according to claim 1, wherein
the operation unit is configured to receive a setting operation for preventing the image content to be displayed on at least one of the plurality of display screens from being changed to different image content, and
the display controller does not change the image content to be displayed on the at least one of the plurality of display screens for which the setting operation is received.

18. The display control device according to claim 2, wherein
the first display screen and the second display screen are screens resulting from dividing an area of a display screen of a single display unit.

19. The display control device according to claim 2, wherein
a first display unit provided in the vehicle includes the first display screen,
a second display unit provided in the vehicle includes the second display screen, and
the first display unit and the second display unit are separately and independently provided in the vehicle.

20. A display device comprising:
the display control device according to claim 1; and
the plurality of display screens.

21. A display control method comprising:
determining, by a determiner, a seating location of an occupant who has operated an operation unit configured to receive an operation for selecting image content to be displayed on at least one of a plurality of display screens provided in a vehicle;
obtaining, by an obtainer, an autonomous driving level of the vehicle;
causing, by a display controller, the image content to be displayed on at least one of the plurality of display screens based on the operation received by the operation unit, the seating location, and the autonomous driving level; and
when an operation for displaying new image content is received by the operation unit while the image content is displayed on at least one of the plurality of display screens, changing, by the display controller, a display mode of the image content that has already been displayed, to display the new image content based on the seating location and the autonomous driving level.

22. A non-transitory computer-readable recording medium for use in a computer, the recording medium having recorded thereon a computer program executable by the computer to execute the display control method according to claim 21.
